(19) United States
(12) Patent Application Publication
(10) Pub. No.: US 2026/0158979 A1
(43) Pub. Date: Jun. 11, 2026

(54) SEAT HEAD RESTRAINT TILTING MECHANISM FOR FORE-AFT MOVEMENT

(71) Applicant: FCA US LLC, Auburn Hills, MI (US)

(72) Inventor: Aman Kumar Jha, Chennai (IN)

(21) Appl. No.: 18/973,217

(22) Filed: Dec. 9, 2024

(51) Int. Cl. B60N 2/865; B60N 2/818

(52) U.S. Cl. CPC B60N 2/865; B60N 2/818

(57) ABSTRACT

A seat having a head restraint attached to and movable relative to a seat back in an upward direction, a downward direction, a forward direction, and a rearward direction. A position of the head restraint in the forward direction and rearward direction is controlled by a movement mechanism that includes a first plate that is fixed and has a first groove formed therein, a second plate that is movable relative to the first plate and has a second groove formed therein, and a bearing component that is positioned between the first plate and the second plate and located in each of the first and second grooves. The first groove has a plurality of seats positioned there along, and movement of the second plate relative to the first plate moves the bearing component through the first groove to a selected seat of the plurality of seats.

### FIELD

The present disclosure relates to a seat head restraint tilting mechanism for fore-aft movement.

### BACKGROUND

This section provides background information related to the present disclosure which is not necessarily prior art.

Vehicle seats may include a head restraint attached to the seat that can move in four directions. The first two directions include moving the head restraint either up or down to adjust a distance of the head restraint relative to a seat back of the vehicle seat. The second two directions include tilting the head restraint in either the forward direction or the rearward direction (otherwise known as “fore-aft” movement) relative to the seat back. Because occupants of the seat may have different heights and sizes, the ability of the head restraint to move in the above-described four directions can ensure that the head restraint is positioned in the safest position for a particular occupant while maximizing comfort.

Fore-aft movement of the head restraint can also be particularly important because it can provide an increased safety rating for a vehicle including such a feature. The mechanisms that permit the fore-aft movement of the head restraint, however, can be mechanically complex, which can increase the costs associated with the vehicle seat. Accordingly, it is desirable for an improved vehicle seat that includes a movable head restraint that can have fore-aft movement with a simpler movement mechanism.

### SUMMARY

This section provides a general summary of the disclosure, and is not a comprehensive disclosure of its full scope or all of its features.

According to a first aspect of the present disclosure, there is provided a vehicle seat that includes a seat cushion; a seat back attached to the seat cushion; and a head restraint attached to the seat back, wherein the head restraint is movable relative to the seat back in an upward direction, a downward direction, a forward direction, and a rearward direction, a position of the head restraint in the forward direction and rearward direction is controlled by a movement mechanism that includes a first plate that is fixed and has a first groove formed therein, a second plate that is movable relative to the first plate and has a second groove formed therein, and a bearing component that is positioned between the first plate and the second plate and located in each of the first and second grooves, and the first groove has a plurality of seats positioned there along, and movement of the second plate relative to the first plate moves the bearing component through the first groove to a selected seat of the plurality of seats.

According to the first aspect, the first groove is in the shape of a loop including a section having the plurality of seats and an elongated section that is connected to the section having the plurality of seats.

According to the first aspect, the second groove laterally extends across a width of the second plate and includes a first side and an opposite second side.

According to the first aspect, as the bearing component moves through the first groove to a selected seat of the plurality of seats the bearing component also moves through the second groove in directions toward the first side and the opposite second side.

According to the first aspect, the bearing component is comprised of a spherical member.

According to the first aspect, the first groove includes a plurality of angled walls that direct the bearing component through the first groove as the second plate is moved relative to the first plate.

According to the first aspect, the vehicle seat further comprises a biasing spring that biases the head restraint to a most rearward position relative to the seat back.

According to the first aspect, the bearing component moves through the elongated section of the first groove when the biasing spring biases the head restraint from a most forward position relative to the seat back to the most rearward position.

According to the first aspect, each of the seats is defined by a surface of the first groove that extends laterally outward from a linear surface of the first groove.

According to the first aspect, the surface of the first groove that defines the seat is inclined relative to the linear surface by an angle that ranges between about two degrees to about five degrees.

According to a second aspect of the present disclosure, there is provided a vehicle seat that may include a seat cushion; a seat back attached to the seat cushion; and a head restraint attached to the seat back, wherein the head restraint is movable relative to the seat back in an upward direction, a downward direction, a forward direction, and a rearward direction, a position of the head restraint in the forward direction and rearward direction is controlled by a movement mechanism that includes an arcuate bottom plate that is fixed and has a first groove formed therein, an arcuate top plate that is movable relative to the bottom plate and has a second groove formed therein, and a spherical bearing that is positioned between the bottom plate and the top plate and located in each of the first and second grooves, and the first groove has a plurality of seats positioned there along, and movement of the top plate relative to the bottom plate moves the spherical bearing component through the first groove to a selected seat of the plurality of seats.

According to the second aspect, the first groove is in the shape of a loop including a section having the plurality of seats and an elongated section that is connected to the section having the plurality of seats.

According to the second aspect, the second groove laterally extends across a width of the top plate and includes a first side and an opposite second side.

According to the second aspect, as the spherical bearing moves through the first groove to a selected seat of the plurality of seats the spherical bearing also moves through the second groove in directions toward the first side and the opposite second side.

According to the second aspect, the first groove includes a plurality of angled walls that direct the spherical bearing through the first groove and along the second groove in directions toward the first side and the opposite second side as the second plate is moved relative to the first plate.

According to the second aspect, the vehicle seat may also include a biasing spring that biases the head restraint to a most rearward position relative to the seat back.

According to the second aspect, the spherical bearing moves through the elongated section of the first groove when the biasing spring biases the head restraint from a most forward position relative to the seat back to the most rearward position.

According to the second aspect, each of the seats is defined by a surface of the first groove that extends laterally outward from a linear surface of the groove.

According to the second aspect, the surface of the first groove that defines the seat is inclined relative to the linear surface by an angle that ranges between about two degrees to about five degrees.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an isometric perspective view of an example vehicle seat including a movable head restraint according to a principle of the present disclosure;

FIG. 2 is an isometric perspective view of a head restraint support structure that permits movement of the head restraint in four directions;

FIG. 3A is a top perspective view of a movement mechanism according to a principle of the present disclosure that permits fore-aft movement of the head restraint;

FIG. 3B is a rear perspective view of the movement mechanism illustrated in FIG. 3A;

FIG. 4 is an isometric perspective view of a bottom plate of the movement mechanism illustrated in FIGS. 3A and 3B;

FIG. 5A is a top perspective view of a top plate of the movement mechanism illustrated in FIGS. 3A and 3B;

FIG. 5B is a rear perspective view of the top plate of the movement mechanism illustrated in FIGS. 3A and 3B; and

FIG. 6 illustrates movement of a component of the movement mechanism illustrated in FIGS. 3A and 3B positioned between the top and bottom plates as the head restraint is moved in the fore-aft directions.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

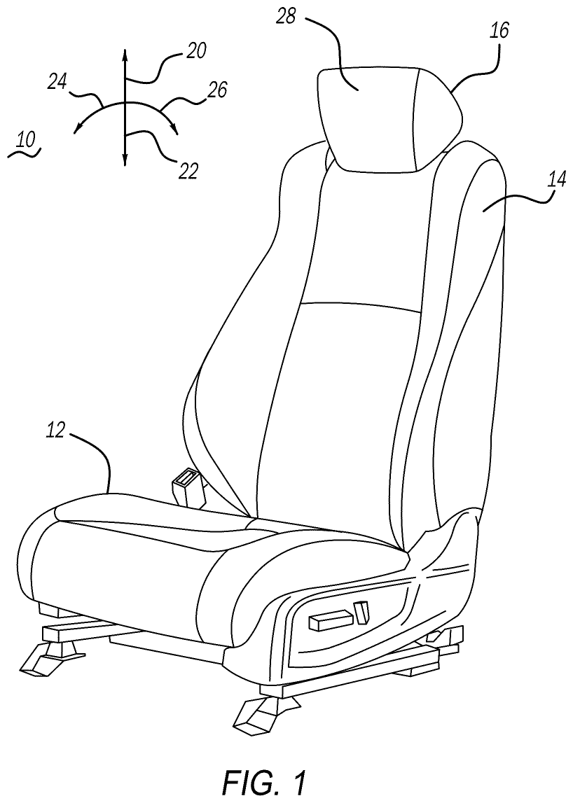

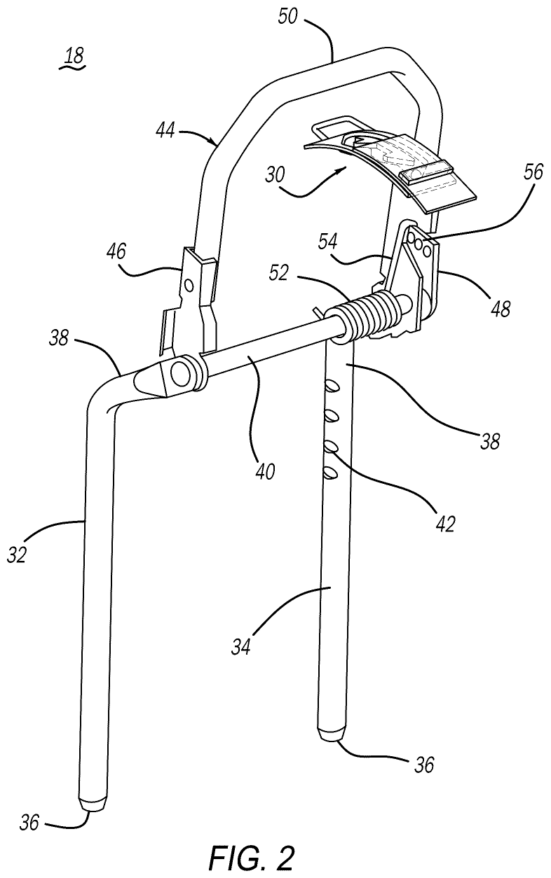

FIG. 1 illustrates an example seat 10 that can be part of a vehicle (not shown). Seat 10 includes a seat cushion 12 and a seat back 14 attached to the seat cushion 12. A head restraint 16 having a support structure 18 (FIG. 2) that permits movement of the head restraint 16 relative to the seat back 14 in four directions is attached to seat back 14. The four directions that head restraint 16 can move include an upward direction 20, a downward direction 22, a forward direction 24, and a rearward direction 26.

Now referring to FIG. 2, support structure 18 that attaches head restraint 16 to seat back 14 is illustrated. When viewing FIG. 2 it should be understood that a head restraint cushion 28 (FIG. 1) is omitted so that the various features of support structure 18 and a movement mechanism 30 that permits head restraint 16 to move in the forward and rearward directions 24, 26 can be seen.

Support structure 18 includes a first leg 32 and a second leg 34 that are each configured to be receiving in a pair of elongated recesses (not shown) that are located in seat back 14. Each leg 32 and 34 includes a distal end 36 that can be located in the recess and a proximate end 38, where proximate ends 38 are connected to a pivot pin 40 that interconnects legs 32, 34. At least one of the legs 32, 34 may include a plurality of detents 42 that can be engaged by, for example, a spring-biased protrusion (not shown) that is located in at least one of the elongated recesses for engagement with one of the detents 42. When an occupant retracts the protrusion (not shown) by pressing a button (not shown), the protrusion disengages from detent 42 at which time the occupant can lift up or push down the head restraint 16 to adjust a up/down position (i.e., head restraint 16 can be moved in either the upward direction 20 or the downward direction 22) of the head restraint 16 relative to seat back 14.

A head restraint cushion support assembly 44 is attached to pivot pin 40. Head restraint cushion support assembly 44 includes a first bracket 46 attached to pivot pin 40 at a position proximate first leg 32 and a second bracket 48 attached to pivot pint 40 at a position proximate second leg 34. A U-shaped cushion support bar 50 is attached to the first bracket 46 and the second bracket 48. Head restraint cushion 28 (FIG. 1) is attached to U-shaped cushion support bar 50.

A biasing spring 52 is fixed to pivot pin 40 that is configured to bias head restraint cushion support assembly 44 in the rearward direction 26. In this regard, an arm 54 of spring 52 can be attached to one of a plurality of apertures 56 provided in second bracket 48 that can be selected depending on the desired most rearward position of the head restraint 16. If head restraint 16 is desired to be moved in the forward direction 24, however, movement mechanism 30 includes various features that prevent biasing spring 52 from returning head restraint 16 to the most rearward position unless desired.

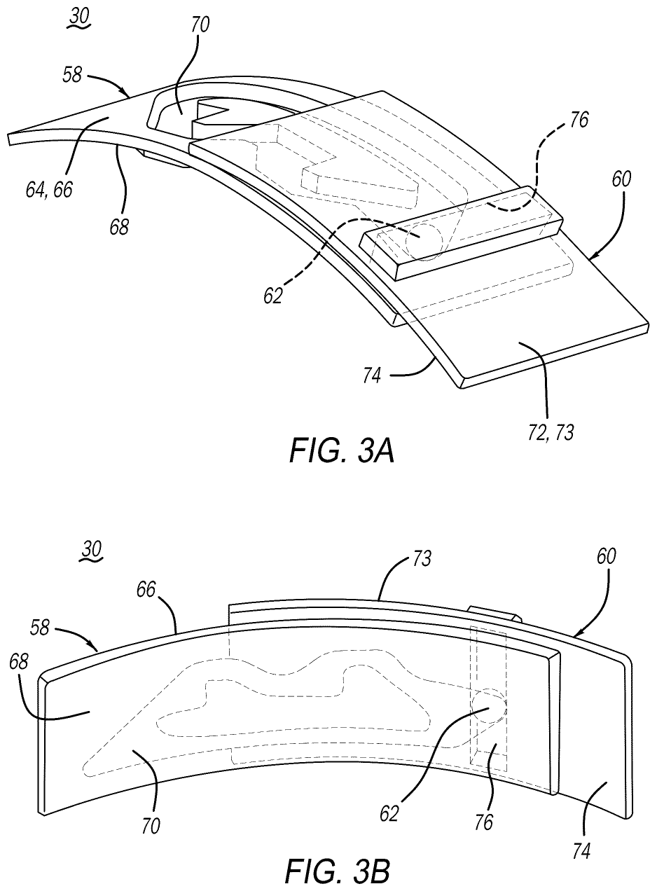

Movement mechanism 30 is more clearly illustrated in FIGS. 3A to 5B. In general, movement mechanism 30 includes a first or bottom plate 58, a second or top plate 60, and a bearing component 62 positioned between the bottom plate 58 and top plate 60. Bottom plate 58 may be fixed to a component of support structure 18 such as pivot pin 40 and top plate 60 may be fixed to an underside of head restraint cushion 28 such that top plate 60 may move relative to bottom plate 58 as head restraint cushion support assembly 44 and the attached head restraint cushion 28 are moved relative to pivot pin 40. As top plate 60 moves relative to bottom plate 58, bearing component 62 can move through a plurality of positions between top plate 60 and bottom plate 58 to adjust and lock a position of head restraint 16 in the forward direction 24 relative to seat back 14, as will be described in more detail below.

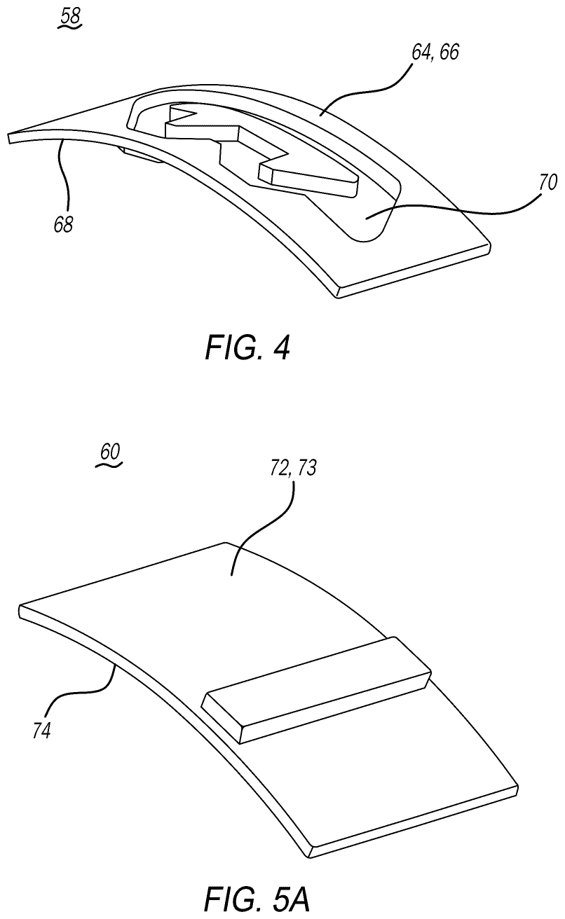

As best shown in FIG. 4, bottom plate 58 includes a first arcuate plate body 64 having a first upper surface 66 and an opposite first lower surface 68, and which may be stamped or formed to have a first bearing component groove 70 provided in the first upper surface 66. First groove 70 has a loop shape and serves a guide path for bearing component 62 as top plate 60 moves relative to bottom plate 58. Bottom plate 58 may be formed of a rigid material such as a metal material, but may also be formed of a polymeric material if desired.

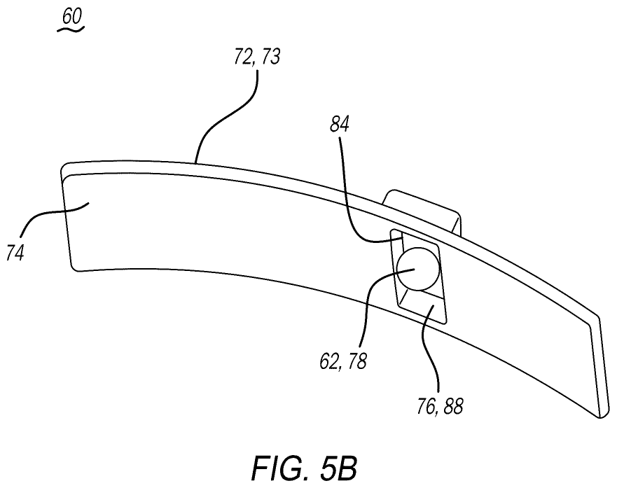

As best shown in FIGS. 5A and 5B, top plate 60 includes a second arcuate plate body 72 having a second upper surface 73 and an opposite second lower surface 74, and which may be stamped or formed to have a second bearing component groove 76 provided in the second lower surface 74. Second groove 76 extends laterally across a width of top plate 60, and permits bearing component 62 to move from side to side across second groove 76 while maintaining bearing component 62 positioned between the bottom plate 58 and the top plate 60 as the bearing component also moves through first groove 70. Top plate 60 may be formed of a rigid material such as a metal material, but may also be formed of a polymeric material if desired.

Bearing component 62 may have a spherical body 78 that permits bearing component 62 to roll as it travels through each of the first and second grooves 70, 76. Bearing component 62 may be formed of a rigid material such as a metal material, but may also be formed of a polymeric material if desired.

The use of movement mechanism 30 permits an occupant to simply and lightly push head restraint 16 in the forward direction 24 to adjust a position of head restraint 16 relative to seat back 14. Put another way, no latches need to be actuated, which makes movement of head restraint 16 easier in comparison to conventional fore-aft movement of head restraint 16.

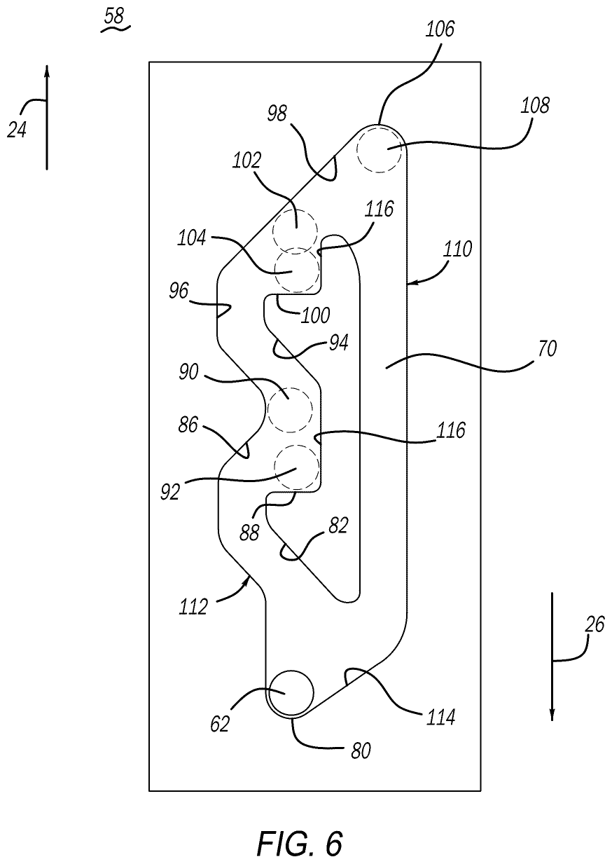

As noted above, top plate 60 is movable relative to bottom plate 58. Because bearing component 62 is located in second groove 76 between bottom plate 58 and top plate 60, movement of top plate 60 relative to bottom plate 58 can force bearing component 62 to travel through groove 70 to adjust a position of head restraint 16. Referring to FIG. 6, groove 70 includes an initial or first seat 80 that bearing component 62 rests when head restraint 16 is located at the most rearward position relative to seat back 14. As head restraint 16 is pushed forward to adjust a position thereof, bearing component 62 is urged in the forward direction 24 through first groove 70 until it reaches a first angled section or wall 82 which directs bearing component 62 to the left in FIG. 6 and also to the left side 84 of second groove 76.

After being directed by first wall 82 and as the occupant continues to push head restraint 16 in the forward direction 24, bearing component 62 will travel through first groove 70 until reaching a second angled section or wall 86 that will direct bearing component through first groove 70 to the right in FIG. 6 and also in a direction to the right side 88 of second groove 76. Second wall 86 is located proximate a second seat 88 of first groove 70. To seat bearing component 62 in second seat 88, head restraint 16 is further pushed in the forward direction 24 past second seat 88 until bearing component 62 reaches a position 90 at which time the occupant can cease pushing head restraint 16 in the forward direction 24. Because support structure 18 includes biasing spring 52 that biases the U-shaped cushion support bar 50 in the rearward direction 26, top plate 60 will be pulled in the rearward direction 26 which will also pull bearing component 62 back towards and into second seat 88, which is located forward of first seat 80. The position of bearing component 62 when seated in second seat 88 is indicated at 92.

If the occupant desires head restraint 16 to be located at an even more forward position in comparison to second seat 88, the occupant may again push head restraint in the forward direction 24, which will again cause top plate 60 and bearing component to move in the forward direction 24 relative to bottom plate 58. As bearing component 62 is pushed in the forward direction 24 from second seat 88, bearing component 62 will reach a third angled section or wall 94 that will direct bearing component 62 through first groove 70 back to the left in FIG. 6 and to the left side 84 of second groove 76 of top plate 60 before reaching a linearly arranged fourth wall 96 that directs bearing component 62 in the forward direction 24 until reaching a fifth angled wall 98 that directs bearing component 62 through first groove 70 to the right in FIG. 6 and also in a direction toward the right side 88 of second groove 76. Fifth wall 98 is located proximate a third seat 100.

To seat bearing component 62 in third seat 100, head restraint 16 is further pushed in the forward direction 24 past third seat 100 until bearing component 62 reaches a position 102 at which time the occupant can cease pushing head restraint 16 in the forward direction 24. Because support structure 18 includes biasing spring 52 that biases the U-shaped cushion support bar 50 in the rearward direction 26, top plate 60 will be pulled in the rearward direction 26 which will also pull bearing component 62 back towards and into third seat 100, which is located forward of first and second seats 80 and 88. The position of bearing component 62 when seated in third seat 100 is indicated at 104.

While first groove 70 is illustrated as having only two positions (i.e., second and third seats 88 and 100) that are located forward of the most rearward position of head restraint 16 (i.e., at first seat 80), it should be understood that the configuration of first groove 70 is only an example and can be designed to have additional forward positions (i.e., seats), as desired. The important aspect to keep in mind is that movement mechanism 30 is a simple and elegant solution to provide an adjustable head restraint 16 that does not require a lot of effort to adjust a position thereof in comparison to a conventional head restraint that uses a latch mechanism.

If occupant desires to return the head restraint 16 to the most rearward position (i.e., move bearing component 62 back to the first seat 80), the occupant simply needs to push head restraint in the forward direction 24, which will force bearing component 62 out of third seat 100 and into contact with fifth wall 98 at which time bearing component 62 will be directed forward through first groove 70 to the right in FIG. 6 and also further towards the right side 88 of second groove 76. As bearing component travels along fifth wall 98, bearing component 62 will eventually reach a most forward or fourth seat 106. The position of bearing component 62 when located in fourth seat 106 is indicated at 108, and the occupant will no longer be able to continue pushing head restraint 16 in the forward direction 24.

Upon the occupant ceasing to apply force to head restraint 16 in the forward direction 24, the biasing force of biasing spring 52 will urge U-shaped cushion support bar 50 in the rearward direction 26, which will also draw top plate 60 and bearing component 62 in the rearward direction 26. Specifically, first groove 76 includes an elongated section 110 that is separated from a section 112 of first groove 70 that includes first, second, and third seat 80, 88, and 100. As bearing component 62 is pulled in the rearward direction 26, the bearing component 62 will travel through elongated section 110 until reaching a sixth angled section or wall 114 that will direct bearing component 62 in a direction toward first seat 80 (i.e., the most rearward position of head restraint 16).

While second and third seats 88 and 100 are illustrated as being surfaces that are arranged at an angle that is approximately ninety degrees relative to linear surfaces 116 of first groove 70 located proximate thereto, it should be understood that these surfaces may be slightly inclined by an angle that ranges between about two degrees to about five degrees to ensure that bearing component does not “slip” from the second and third seats 88 and 100.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle seat comprising:
a seat cushion;
a seat back attached to the seat cushion; and
a head restraint attached to the seat back,
wherein the head restraint is movable relative to the seat back in an upward direction, a downward direction, a forward direction, and a rearward direction,
a position of the head restraint in the forward direction and rearward direction is controlled by a movement mechanism that includes a first plate that is fixed and has a first groove formed therein, a second plate that is movable relative to the first plate and has a second groove formed therein, and a bearing component that is positioned between the first plate and the second plate and located in each of the first and second grooves,
the first groove has a plurality of seats positioned there along, and movement of the second plate relative to the first plate moves the bearing component through the first groove to a selected seat of the plurality of seats.

2. The vehicle seat according to claim 1, wherein the first groove is in the shape of a loop including a section having the plurality of seats and an elongated section that is connected to the section having the plurality of seats.

3. The vehicle seat according to claim 1, wherein the second groove laterally extends across a width of the second plate and includes a first side and an opposite second side.

4. The vehicle seat according to claim 1, wherein as the bearing component moves through the first groove to a selected seat of the plurality of seats the bearing component also moves through the second groove in directions toward the first side and the opposite second side.

5. The vehicle seat according to claim 1, wherein the bearing component is comprised of a spherical member.

6. The vehicle seat according to claim 1, wherein the first groove includes a plurality of angled walls that direct the bearing component through the first groove as the second plate is moved relative to the first plate.

7. The vehicle seat according to claim 2, further comprising a biasing spring that biases the head restraint to a most rearward position relative to the seat back.

8. The vehicle seat according to claim 7, wherein the bearing component moves through the elongated section of the first groove when the biasing spring biases the head restraint from a most forward position relative to the seat back to the most rearward position.

9. The vehicle seat according to claim 1, wherein each of the seats is defined by a surface of the first groove that extends laterally outward from a linear surface of the first groove.

10. The vehicle seat according to claim 9, wherein the surface of the first groove that defines the seat is inclined relative to the linear surface by an angle that ranges between about two degrees to about five degrees.

11. A vehicle seat comprising:
a seat cushion;
a seat back attached to the seat cushion; and
a head restraint attached to the seat back,
wherein the head restraint is movable relative to the seat back in an upward direction, a downward direction, a forward direction, and a rearward direction,
a position of the head restraint in the forward direction and rearward direction is controlled by a movement mechanism that includes an arcuate bottom plate that is fixed and has a first groove formed therein, an arcuate top plate that is movable relative to the bottom plate and has a second groove formed therein, and a spherical bearing that is positioned between the bottom plate and the top plate and located in each of the first and second grooves,
the first groove has a plurality of seats positioned there along, and movement of the top plate relative to the bottom plate moves the spherical bearing component through the first groove to a selected seat of the plurality of seats.

12. The vehicle seat according to claim 11, wherein the first groove is in the shape of a loop including a section having the plurality of seats and an elongated section that is connected to the section having the plurality of seats.

13. The vehicle seat according to claim 11, wherein the second groove laterally extends across a width of the top plate and includes a first side and an opposite second side.

14. The vehicle seat according to claim 11, wherein as the spherical bearing moves through the first groove to a selected seat of the plurality of seats the spherical bearing also moves through the second groove in directions toward the first side and the opposite second side.

15. The vehicle seat according to claim 14, wherein the first groove includes a plurality of angled walls that direct the spherical bearing through the first groove and along the second groove in directions toward the first side and the opposite second side as the second plate is moved relative to the first plate.

16. The vehicle seat according to claim 12, further comprising a biasing spring that biases the head restraint to a most rearward position relative to the seat back.

17. The vehicle seat according to claim 16, wherein the spherical bearing moves through the elongated section of the first groove when the biasing spring biases the head restraint from a most forward position relative to the seat back to the most rearward position.

18. The vehicle seat according to claim 11, wherein each of the seats is defined by a surface of the first groove that extends laterally outward from a linear surface of the groove.

19. The vehicle seat according to claim 18, wherein the surface of the first groove that defines the seat is inclined relative to the linear surface by an angle that ranges between about two degrees to about five degrees.
